(19) United States
(12) Patent Application Publication
(10) Pub. No.: US 2012/0067662 A1
(43) Pub. Date: Mar. 22, 2012

(54) DRIVE ASSISTANCE DEVICE, WHEELCHAIR AND METHOD FOR DETERMINATION OF THE MANUAL DRIVING FORCE OF A WHEELCHAIR DRIVER

(75) Inventors: Thomas Birmanns, Balingen (DE); Ralf Ledda, Albstadt (DE); Bernd Engels, Reutlingen (DE); Paul-Gerhard Bitzer, Albstadt (DE)

(73) Assignee: Ulrich Alber GmbH, Albstadt (DE)

(21) Appl. No.: 13/226,688

(22) Filed: Sep. 7, 2011

(30) Foreign Application Priority Data
Sep. 22, 2010 (DE) 10 2010 037 705.8
Sep. 22, 2010 (DE) 10 2010 037 710.4

(51) Int. Cl. B60K 26/00

(52) U.S. Cl. 180/315

(57) ABSTRACT

A drive assistance device for a wheelchair having a drive motor, a running wheel and a sensor device which is adapted to detect a driving force manually induced into the running wheel. A control unit which is adapted to control the drive motor for driving the running wheel depending on a driving force manually induced by the user into the running wheel has a user force determination operational mode in which the maximum force of the user can be determined.

### FIELD OF INVENTION

The invention relates to a drive assistance device for a wheelchair, a wheelchair having a drive assistance device and a method for determination of the manual driving force of a wheelchair driver.

### BACKGROUND

A drive assistance device of the before-mentioned kind is known from DE 198 57 786 A1, which is incorporated by reference herein in its entirety. Such a drive assistance device for a wheelchair comprises a drive motor, a running wheel, a sensor device, which is adapted to sense a driving force manually applied to the running wheel, and a control unit, which is adapted to control the drive motor for driving the running wheel depending on the driving force manually applied to, i.e. induced into the running wheel in accordance with a support level.

Such wheelchairs provide the possibility to a wheelchair driver to manually drive the wheelchair, for instance via respective hand rims at the running wheels. However, they support the manual drive as required, by means of the drive motor or the drive motors. For this purpose, the sensor device determines the respective force manually applied to the hand rim and the control unit controls the drive motor or the drive motors for driving the running wheel depending on the force induced into the hand rim in accordance with a support level.

Drive systems of the before-mentioned kind are therefore adapted to physically relieve the wheelchair driver. As a driving force or driving torque, respectively, on the one hand the manual force manually applied by the wheelchair driver to the running wheel, for example via a hand rim, and the torque resulting therefrom and, in addition thereto, an electric driving force and a corresponding driving torque of the drive motor, respectively, which are generated in that the control unit controls the drive motor correspondingly depending on the manually applied force in accordance with a support level are effective. During this kind of operation, the manual driving force and the torque resulting therefrom as well as the torque of the drive motor act in the same rotational direction. Both torques are added as far as their absolute value is concerned. The same applies in case of a breaking operation.

As a result, the wheelchair driver therefore only supplies a portion of the force necessary for locomotion or for breaking and, therefore, can negotiate even ascending and descending slopes without major efforts. The proportion between the manually induced forces and the torque generated by the electric motor, that is the support level, can be set in accordance with the personal requirements of the wheelchair driver and, as the case may be, can be pre-selected.

The decision whether use of such drive assistance device makes sense from a therapeutically point of view or is even mandatory depends particularly on the capability of the wheelchair driver. In order to determine this, it is possible that the wheelchair driver conducts driving tests without motor assistance and, by doing so, specifically negotiates ramps of various slopes. Depending on which kind of slope he can negotiate, the maximum force of the wheelchair driver can be determined. In order to do so, it is necessary to provide a test course having various ramps, which naturally requires considerable space.

### SUMMARY OF THE INVENTION

The invention aims to provide an apparatus and a method which allow determination of the maximum force of a wheelchair driver for driving a wheelchair in a simple manner, specifically under economic considerations and the issue of the requirements of space.

According to one aspect, a drive assistance device for a wheelchair is provided comprising a drive motor, a running wheel, a sensor device which is adapted to determine a driving force manually applied to the running wheel and a control unit which is adapted to control the drive motor for driving the running wheel depending on the driving force manually induced by the user into the running wheel in accordance with a support level. The control unit of the drive assistance device according to the present invention comprises a user force determination operational mode which is adapted to control the drive motor such that, as a reaction to a driving force manually induced into the running wheel, a torque is generated in direction opposite to the direction in which the driving force manually induced into the running wheel is effective.

While in the case of known drive assistance devices according to the prior art the torque of the motor usually acts in the same direction as the manually induced torque in order to support the propulsion or to enforce the breaking force, in the case of the drive assistance device according to the present invention the motor torque is applied in a direction opposite to the effective direction of the manual drive in the case of the user force determination operational mode. Accordingly, a resistance against the manual driving force is generated. From the magnitude of this resistance, the manually applied force can be determined.

Since the drive assistance device itself generates a corresponding resistance, the necessity to provide external resistance in the form of, for instance, a ramp becomes obsolete. The manual driving force which is applied by a wheelchair driver therefore can be determined by the drive assistance device itself.

In an advantageous embodiment of the invention, the torque opposite to the effective direction of the driving force manually induced into the running wheel is increased step by step. Preferably, it is started with a low counter torque or breaking torque, respectively, acting against the direction in which the wheelchair driver pushes. This simulates a drive uphill with a moderate slope. This breaking torque or counter torque, respectively, is successively increased overtime, namely as long as the test person finally is no longer able to manually rotate the wheel. From that counter torque at which the user still had been able to cause a rotational movement, a maximum force of the user can be determined. This maximum force represents a dimension which serves to determine which kind of slope a wheelchair driver can negotiate.

In another advantageous embodiment of the invention, such measurements can be effected independently for both sides, that means for the left hand and the right hand. In the common case where there are different maximum forces on the left hand side and the right hand side, in such case the lower force is to be used as a reference value since only in this way driving straight on slopes can be insured.

In still another advantageous embodiment of the invention, the control unit is configured such that it is capable of transmitting measuring data to a data processing device, for instance a commercially available standard personal computer, in real time. This synchronous data transmission not only insures that upon completion of the measuring an evaluation is immediately available, but also provides the possibility for a therapist to monitor the measuring results during the running measuring and, as the case may be, intervene or even stop the measuring in case this should be necessary for medical reasons.

The drive assistance device according to the present invention, as well as a wheelchair according to the present invention, provided with such a drive assistance device, provide the advantage that the capability of the user can be tested with this device itself without the necessity to provide ramps needing corresponding space.

In case of a method according to the present invention, such a wheelchair equipped with a drive assistance device according to the present invention is supported or jacked up, respectively, such that the running wheels are freely rotatable. The user then takes a seat in the wheelchair and can freely rotate the driving wheels wherein the sole counterforce is the driving torque of the drive motor acting against this rotation.

In a manner known as such, the drive assistance device according to the present invention can comprise a hand rim through which the force can be manually induced into the running wheel. The drive motor can be designed as an electric motor and, specifically, as a hub motor. Such a drive motor can be disposed together with a rechargeable battery and the control unit in the hub of the running wheel.

### BRIEF DESCRIPTION OF THE DRAWINGS

In the following, the invention is further explained by way of example in connection with the preferred embodiments, making reference to the drawings, in which:

FIG. 1 is an embodiment of a wheelchair according to the present invention having a drive assistance device according to the present invention, and

FIG. 2 is an exemplary chart of the proportion between a climbing capability indicated in percent and a manual driving force.

### DETAILED DESCRIPTION OF THE INVENTION

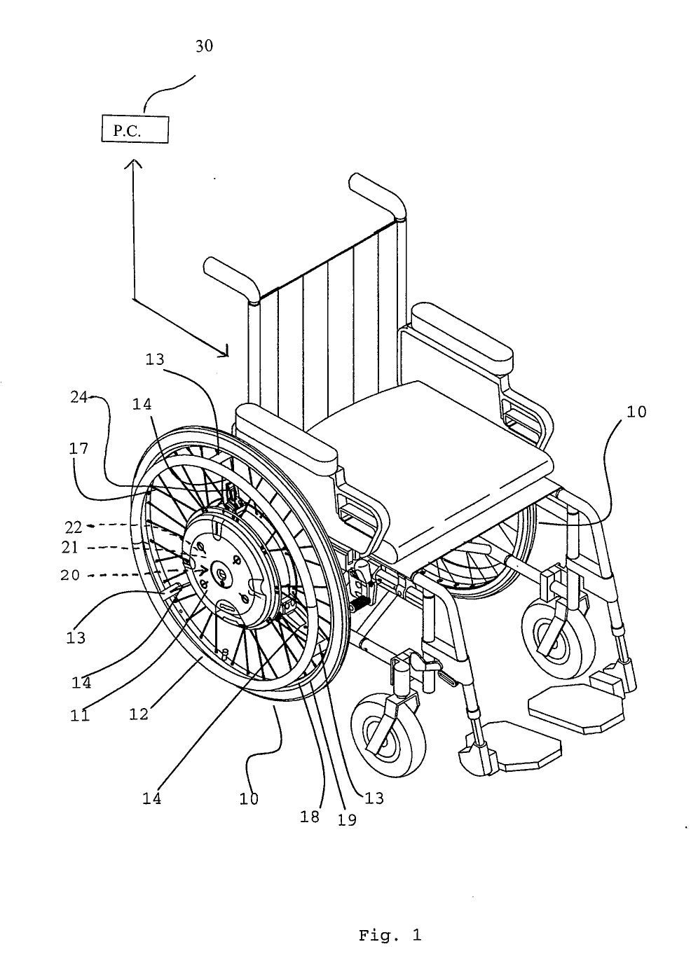

FIG. 1 shows a perspective depiction of a wheelchair having two running wheels 10. Each running wheel 10 has a hub 11 which is connected via commercially available spokes 17 with a rim 18 on which a tire 19 is mounted. Inside the hub 11 are located a drive motor which is designed as an electric motor 20, a rechargeable battery 21 and a control unit 22.

A hand rim 12 is connected with the hub 11 via three struts 13 and three spoke elements 14.

In case a manual force is induced into the hand rim 12, this force is transmitted directly to the hub 11 via the struts 13 and the spoke elements 14. At least one sensor device 24 which is disposed at at least one of said struts 13 and/or said spoke elements 14 detects the effect of the force which acts on a spoke element 14. This effect is on the one hand a tension generated in the spoke element 14 and on the other hand a deformation of the spoke element 14. At least one of these effects is sensed, respectively, and serves as a scale for the force induced into the hand rim 12. In accordance with this scale, the drive motor is controlled by the control unit for providing a torque. In this connection, variable or fixed pre-programmed support levels can be provided.

Suitable sensor devices and sensors, respectively, are for instance disclosed in EP 0 945 113 A2, which is incorporated by reference herein.

In addition to the common operational mode which increases the manually induced driving force or braking force, respectively, by means of electric motor in that this electric motor applies a torque in the same direction in which the manually induced force acts, the drive assistance device according to the present invention has additionally a user force determination operational mode in which a torque is generated in a direction opposite to the effective direction of the driving force manually induced into the running wheel 10.

In order to conduct a measurement of the maximum force, the wheel chair shown in FIG. 1 is supported or jacked up, respectively, such that the running wheels 10 are freely rotatable. Then, the control unit of the drive assistance device is set into the user force determination operational mode. A user takes a seat in the wheelchair. When the user now starts to rotate the running wheels 10 by manually induced force into the hand rim 12, the drive motor generates a counter torque which is first low, due to a respective control operation of the control unit in the user force determination operational mode. This counter torque is successively increased over time, namely as long as a test person finally is not able to rotate the running wheel 10 via the hand rim 12 any more. This determined propulsion force which has just been sufficient to effect a rotational movement is stored as a maximum force.

The drive assistance device as described above is provided of both the left-hand and right-hand side of the wheelchair. In other words, both running wheels 10 are provided with such drive assistance device. Both such drive assistance devices can be operated independently from each other so that the user force of a wheelchair driver can be determined separately for each side.

The operations as described above is controlled by the control unit 22. The control unit 22 is configured such that it is capable of transmitting measuring data to a data processing device 30, for instance a commercially available standard personal computer, in real time.

Depending on the maximum propulsion force, the gradient of a slope which the wheelchair driver can negotiate without drive assistance can be calculated by the following formula:

$$x ( {F}_{max} ) := 100 \cdot tan ( asin ( \frac{2 \cdot {F}_{max} \cdot {r}_{PR}}{{d}_{W} \cdot {m}_{total} \cdot g} - {μ}_{WC} ) )$$

X(Fₘₐₓ) gradient/% depending on the determined maximum force

Fₘₐₓ measured maximum force

r_{PR} radius of the hand rim

d_{w} diameter of the running wheel

mₜₒₜₐₗ total mass (wheelchair+driver)

g gravitational acceleration

μ_{wc} rolling friction coefficient of the wheelchair

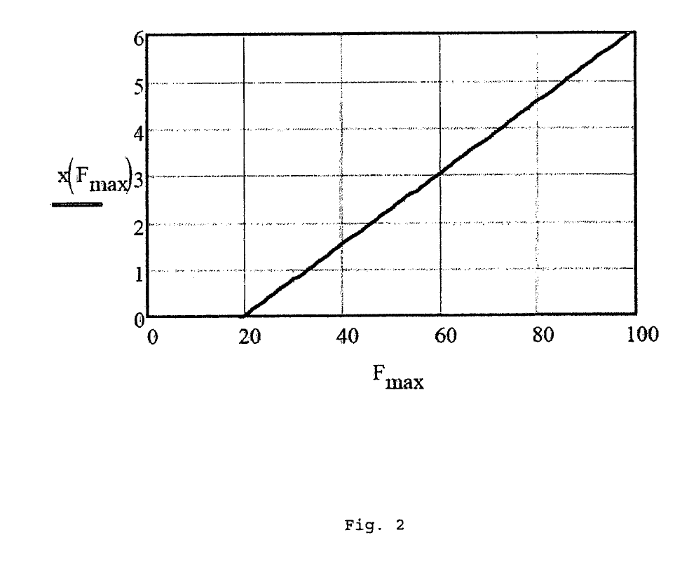

The gradient of the slope which can be negotiated with a certain maximum force depends particularly on the total mass of the wheelchair driver and the wheelchair and the rolling friction coefficient. FIG. 2 shows a corresponding chart for a total mass of 115 kg and a rolling friction coefficient of 0.015.

When the tests as described above show that the possible gradient of a slope is lower than the slopes which a wheelchair driver has to negotiate in his personal environment, it is necessary to provide him with a residual force supporting drive system, i.e. a wheelchair with a generic drive assistance device.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

1. A drive assistance device for a wheelchair comprising:
a drive motor,
a running wheel,
a sensor device which is adapted to detect a driving force manually induced into the running wheel; and
a control unit which is adapted to control said drive motor for driving said running wheel depending on a driving force manually induced into the running wheel by a user in accordance with a support level; the control unit comprising a user force determination operational mode in which the control unit is adapted to control said drive motor such that, as a reaction to a driving force manually induced into the running wheel, a torque is generated in a direction opposite to an effective direction of the driving force manually induced into the running wheel.

2. The drive assistance device according to claim 1, wherein the control unit is adapted such that the drive motor is controlled in the user force determination operational mode such that the torque opposite to the effective direction of the driving force manually induced into the running wheel is increased step by step.

3. The drive assistance device according to claim 2, wherein the control unit is adapted to control the drive motor in the user force determination operational mode such that the increasing of the torque step by step in a direction opposite to the effective direction of the driving force manually induced into the running wheel is stopped when the user is not able to manually rotate the running wheel opposite to this torque any more.

4. The drive assistance device according to claim 3, wherein the control unit is adapted to store the value of a maximum torque and to determine therefrom a maximum force of the user.

5. The drive assistance device according to claim 1, wherein the control unit is adapted to transfer, in the user force determination operational mode, measuring data in real time to an.

6. The drive assistance device according to claim 1, wherein a hand rim, via which force can be manually induced into the running wheel.

7. The drive assistance device according to claim 1, wherein the drive motor is an electric motor and the driving motor, together with rechargeable battery and said control unit, is disposed in the hub of the running wheel.

8. A wheelchair having a drive assistance device according to claim 1.

9. The wheelchair according to claim 8, wherein a drive assistance device is provided on each side of the wheelchair, wherein the drive assistance devices can be operated independently from each other so that the user force of a wheelchair driver can be determined separately for each side.

10. A method for determining the maximum manual propulsion force of a wheelchair driver, wherein a wheelchair according to claim 8 is supported such that its running wheels are freely rotatable, the control unit is set in the user force determination operational mode and, as a reaction to a driving force manually induced into the running wheel, a torque is generated in a direction opposite to the effective direction of the driving force manually induced into the running wheel, wherein the torque opposite to the effective direction of the driving force manually induced into the running wheel is increased step by step until the user can no longer manually rotate the running wheel against said torque.

11. A method for determining the maximum manual propulsion force of a wheelchair driver, wherein a wheelchair according to claim 9 is supported such that its running wheels are freely rotatable, the control unit is set in the user force determination operational mode and, as a reaction to a driving force manually induced into the running wheel, a torque is generated in a direction opposite to the effective direction of the driving force manually induced into the running wheel, wherein the torque opposite to the effective direction of the driving force manually induced into the running wheel is increased step by step until the user can no longer manually rotate the running wheel against said torque.
